(19) United States
(12) Patent Application Publication
(10) Pub. No.: US 2009/0084963 A1
(43) Pub. Date: Apr. 2, 2009

(54) APPARATUS AND METHODS TO PRODUCE ELECTRICAL ENERGY BY ENHANCED DOWN-CONVERSION OF PHOTONS

(75) Inventor: Alan Kost, Tucson, AZ (US)

Correspondence Address: K&L Gates LLP, 1900 MAIN STREET, SUITE 600, IRVINE, CA, 92614-7319, US

(73) Assignee: David, Joseph and Negley

(21) Appl. No.: 12/243,677

(22) Filed: Oct. 1, 2008

Related U.S. Application Data
(60) Provisional application No. 60/976,765, filed on Oct. 1, 2007.

(51) Int. Cl. G01T 1/24; G01J 1/44

(52) U.S. Cl. 250/370.01; 250/206

(57) ABSTRACT

The apparatus and methods of the present disclosure in a broad aspect provide novel devices for producing electricity from light. These apparatus include at least one photon-absorbing semiconductor material, at least one cover layer located above the at least one photon-absorbing material, and a down-conversion material interposed between at least two opposing reflective coatings. The reflective coatings enhance down-conversion of photons to lower energy photons which pass through cover layers to be used by a photon-absorbing semiconductor layer to produce electricity.

### CROSS REFERENCE TO RELATED APPLICATIONS

This application claims the benefit of U.S. Provisional Application No. 60/976,765 filed on Oct. 1, 2007, the entirety of which is hereby incorporated by reference.

### FIELD OF THE INVENTION

The present disclosure generally relates to apparatus and associated methods for producing electricity with photovoltaic cells by enhanced down-conversion of photons.

### BACKGROUND OF THE INVENTION

Throughout history it has been axiomatic that energy, the ability to do work, is required for the functioning of a society. Before the advent of modern powered machines, human and animal energies were directly utilized to perform the work necessary to complete menial household tasks to national projects of grand scale. Now, even to meet the basic necessities of life, members of developed and developing nations recognize that adequate supplies of energy are required to power machines and articles of manufacture designed for such purpose. Preparation and cooking of food, heating or cooling a home, and providing clothing among other things, all ultimately require energy. With the advent of modern electrically operated equipment especially, meeting the necessities of life has become easier and enjoying the current luxuries of life possible. Therefore, electricity has emerged as a form of energy in the last century without which a high or even an acceptable standard of living is not possible.

Electricity production generally requires electricity generation which is converting non-electrical energy to electricity. For electric utilities, it is the first process in the delivery of electricity to consumers. The other processes, electric power transmission and electricity distribution, are normally carried out by the electrical power industry. Electricity is most often generated at a power station by electromechanical generators, primarily driven by heat engines fueled by chemical combustion or nuclear fission.

Production of electricity from carbon-based fuels has a significant drawback. Emissions from electricity generation account for much of the world greenhouse gas emissions, and in the United States, electricity generation accounts for nearly 40% of emissions, the largest of any source. The greenhouse effect, the process by which absorption and emission of infrared radiation by atmospheric gases warm a planet's lower atmosphere and surface is caused by the increased world greenhouse gas emissions.

Human activity since the industrial revolution has increased the concentration of various greenhouse gases, leading to increased radiative forcing from CO₂, methane, tropospheric ozone, chlorofluorocarbons (CFCs) and nitrous oxide. Molecule for molecule, methane is a more effective greenhouse gas than carbon dioxide, but its concentration is much smaller so that its total radiative forcing is only about a fourth of that from carbon dioxide. Some other naturally occurring gases contribute small fractions of the greenhouse effect; one of these, nitrous oxide (N₂O), is increasing in concentration owing to human activity such as agriculture. The atmospheric concentrations of CO₂ and CH₄ have increased by 31% and 149% respectively since the beginning of the industrial revolution in the mid-1700s. These levels are considerably higher than at any time during the last 650,000 years, the period for which reliable data has been extracted from ice cores. From less direct geological evidence it is believed that CO₂ values this high were last attained 20 million years ago. Fossil fuel burning has produced approximately three-quarters of the increase in CO₂ from human activity over the past 20 years.

The present atmospheric concentration of CO₂ is about 385 parts per million (ppm) by volume. Future CO₂ levels are expected to rise due to ongoing burning of fossil fuels and land-use change. The rate of rise will depend on uncertain economic, sociological, technological, and natural developments, but may be ultimately limited by the availability of fossil fuels. However, fossil fuel reserves are sufficient to reach this level and continue emissions past 2100, if coal, tar sands or methane clathrates are extensively used.

Given the harmful effects of global warming and finite sources of available coal and petroleum, other methods of producing electricity have been pursued. One such method is the use of photovoltaics. A photovoltaic cell is a device that converts light energy into electrical energy. A solar cell specifically captures energy from sunlight. Turning solar energy to electrical energy produces zero emissions. Although the use of solar energy had historically been limited to remote places where electrical power lines could not easily reach, government regulations have been imposed to produce at least a certain percentage of electricity from renewable sources of energy. Policies may increasingly make solar energy production less uncommon and perhaps even mainstream.

For this to be possible however, lowered cost and improvements in the efficiencies of photovoltaic cells is necessary. Though investigators have explored numerous avenues for improvement, photovoltaic cells still remain in need of further enhancement to make electricity production from solar energy a reasonable, cost effective alternative to fossil fuel burn generation of electricity. As a result, there is a significant need in the art for apparatus and methods that will enhance efficiencies to improve energy production from a clean source readily available in many parts of the world, sunlight.

### SUMMARY OF THE INVENTION

These and other objects are achieved by the apparatus and methods of the present disclosure which, in a broad aspect, provide novel means for producing electricity from light. Surprisingly, suitably engineered reflective coatings on a down-conversion material included in an apparatus for producing electricity from light may increase the efficiency of the conversion of light to electricity. When a high energy photon which otherwise may not reach a photo-absorbing semiconductor material is down-converted to a usable lower energy photon, the overall efficiency of an apparatus such as a solar cell may be increased.

The apparatus for producing electricity of the present disclosure, in a broad aspect, includes at least one photon-absorbing semiconductor material, at least one cover layer located above the at least one photon-absorbing material, and a down-conversion material interposed between at least two opposing reflective coatings. The down-conversion material is located above the at least one cover layer. The at least two opposing reflective coatings increase the rate of down-conversion of at least one external photon in the down-conversion material to stimulate the emission of at least one internal photon which is exposed to at least one photon-absorbing semiconductor material. Additionally, at least two electrically-conductive materials are in contact with and located below the at least one photon-absorbing semiconductor material.

In another embodiment, the reflective coatings comprise a dielectric material. More specifically and alternatively, the reflective coatings may comprise a material selected from the group consisting of magnesium fluoride, silicon dioxide, tantalum pentoxide, zinc sulfide, and titanium dioxide; or a combination thereof. In another embodiment, the reflective coatings may comprise rugates. In another embodiment, the reflective coatings may be in at least two layers, wherein each layer comprises a different dielectric material.

In another embodiment, the reflective coatings do not externally reflect the at least one external photon having a wavelength of from about 600 nanometers (nm) to about 900 nanometers (nm). Alternatively, the reflective coatings may be approximately parallel.

Alternatively, the provided down-conversion material of an apparatus for producing electricity as disclosed herein may comprise a host and a dopant. The host may comprise quantum dots and the dopant may comprise a transition metal or a rare earth atom in another embodiment.

Alternatively, the down-conversion of an external photon stimulates the emission of at least two internal photons.

In another embodiment, the at least one photon-absorbing semiconductor material is copper indium gallium selenide (CIGS). Alternatively, the at least one photon-absorbing semiconductor material is selected from the group consisting of CIGS, silicon, CdTe, copper indium selenide (CIS), and organic polymer; or a combination thereof.

Alternatively, the at least one external photon has a wavelength capable of being absorbed by the cover layer. In another embodiment, this external photon may have a wavelength of about 300 nm to about 500 nm. The down-conversion in the present apparatus for producing energy, may, alternatively cause the emission of one or more internal photons having a wavelength of about 600 nm to about 900 nm.

In another embodiment, the apparatus for producing electricity of the present disclosure further comprises a substrate layer as bottom layer and a protective layer as top layer. The substrate layer and the protective layer, alternatively, may each comprise glass. In another embodiment, the at least one cover layer comprises an n-type semiconductor. In one embodiment, this n-type semiconductor is CdS.

In another embodiment, the at least one cover layer further comprises at least one additional conductive material located on top of the n-type semiconductor. Alternatively, the at least one additional conductive material comprises ZnO and/or ITO, or a combination thereof. In another embodiment, the electrically-conductive materials in contact with and located below the at least one photon-absorbing semiconductor material comprises molybdenum.

In another embodiment, the present disclosure relates to an apparatus for producing electricity comprising a glass substrate; a layer of molybdenum located above the glass substrate; a layer of CIGS located on top of the layer of molybdenum; a layer of CdS on top of the layer of CIGS; a layer of ZnO and a layer of ITO as cover layers; a down-conversion material interposed between at least two opposing reflective coatings; a metal electrode located above the layer of CIGS; and glass as a top protective layer; wherein the down-conversion material is located above the at least one cover layer; and wherein the at least two opposing reflective coatings increase the rate of down-conversion of the at least one external photon in the down-conversion material to stimulate the emission of at least one internal photon which is exposed to the at least one photon-absorbing material.

A metal electrode may be included with any of the embodiments of the presently described apparatus and methods for producing electricity. A metal electrode in one embodiment is the electric conductive material located above the at least one photon-absorbing material in the presently described apparatus and methods for producing electricity.

The present disclosure also relates to methods of producing electrical energy. In one embodiment, a method of producing electrical energy comprises providing at least one photon-absorbing semiconductor material, providing an external photon to a down-conversion material interposed between at least two opposing reflective coatings which increase the rate of down-conversion of at least one external photon within the down-conversion material to at least one internal photon; and exposing the at least one internal photon to the at least one photon-absorbing semiconductor material to generate charge carriers within the at least one photon-absorbing semiconductor material, wherein the charge carriers migrate to at least two electrically-conductive materials located above and below the at least one photon-absorbing semiconductor material whereby electrical energy is produced.

In another embodiment for the present methods of producing electrical energy, the external photon has a wavelength of about 300 nm to about 500 nm. Alternatively, the at least one internal photon has a wavelength of about 600 nm to about 900 nm. In another embodiment, the reflective coatings are approximately parallel. Alternatively, the reflective coatings comprise a dielectric material. In another embodiment, the reflective coatings comprise a material selected from the group consisting of magnesium fluoride, silicon dioxide, tantalum pentoxide, zinc sulfide, and titanium dioxide; or a combination thereof. Alternatively, the reflective coatings may comprise rugates. In another embodiment, the reflective coatings do not externally reflect the at least one external photon having a wavelength of from about 600 nm to about 900 nm. Alternatively, the reflective coatings are in at least two layers wherein each layer comprises a different dielectric material. In another embodiment, the down-conversion material comprises a host and a dopant. Alternatively, the host comprises quantum dots and the dopant comprises a transition metal or a rare earth atom. One of ordinary skill in the art will recognize what is a transition metal and a rare earth atom in accordance with the present disclosure.

### BRIEF DESCRIPTION OF THE DRAWINGS

FIG. 1 is a schematic graph plotting the quantum efficiency (q) versus wavelength for CIGS as the photon-absorbing semiconductor material.

FIG. 2 is a diagram of an embodiment of an apparatus for producing electrical energy.

FIG. 3 schematically shows the down-conversion of high energy external photons to lower energy photons which are emitted as a result of spontaneous and stimulated emission. The process is enhanced by the presence of reflective coatings sandwiching the down-conversion material.

FIG. 4 shows the process of stimulated emission whereby an external or incoming photon causes the emission of a lower energy photon.

### DETAILED DESCRIPTION OF THE INVENTION

A photovoltaic cell (e.g., solar cell) converts light energy to electrical energy by photogenerating charge carriers (e.g., electrons and holes) in at least one photon-absorbing material such as a semiconductor (e.g., silicon, CIGS, CdTe, CIS, organic polymer, or combinations thereof). The charge carriers (e.g., electrons) move toward electrically-conductive contacts where electrical energy may then be further transported and/or utilized. This photovoltaic effect often occurs within a “module.” A photovoltaic module typically contains at least one photon-absorbing semiconductor material, elements to protect or serve as a substrate to the at least one photon-absorbing material (e.g., glass), and electrical contacts/wiring.

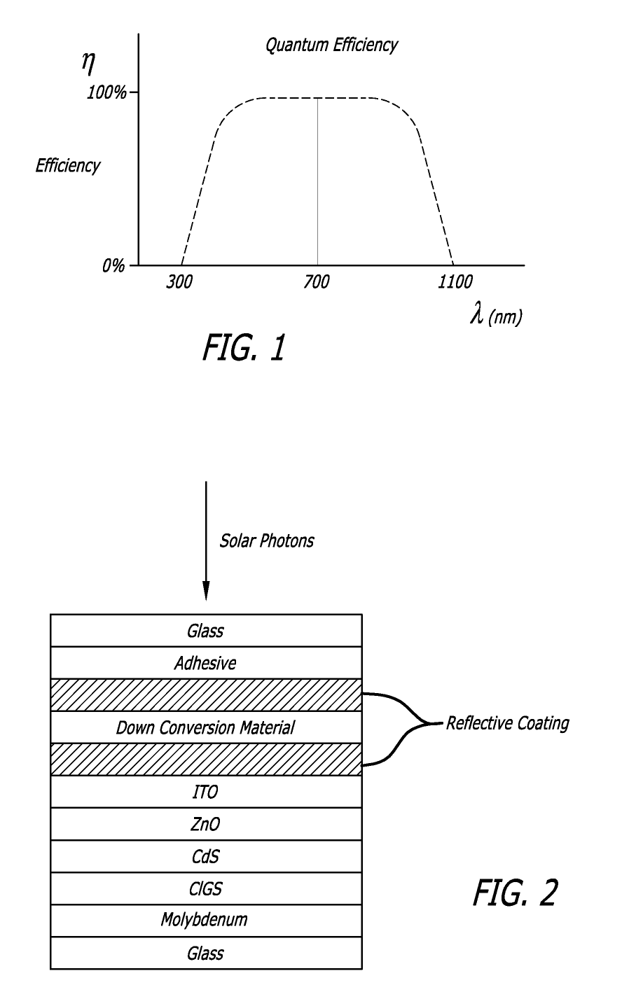

Some photons which may otherwise be useful for producing electrical energy when exposed to a photon-absorbing semiconductor material never are utilized. Often necessary materials covering the photon-absorbing semiconductor material absorb these photons, especially in the blue range of the visible spectrum. FIG. 1 is a schematic graph plotting the quantum efficiency (η) in percentage versus wavelength for CIGS as the at least one photon-absorbing semiconductor material. Quantum efficiency refers to the percentage of absorbed photons that produce electron-hole pairs or charge carriers. One of ordinary skill in the art will recognize that the fall off in quantum efficiency after about 1000 nm wavelength of sunlight is due to the limitations of the photon-absorbing semiconductor material itself such as CIGS. At the other end of the graph, there also is a decline in quantum efficiency, particularly in the visible blue and ultraviolet ranges. This however is because of the residual absorption by one or more layers which cover a photon-absorbing semiconductor material.

Since many of the photons exposed to the photon-absorbing material have greater energy than the band gap energy of the photon-absorbing material, the efficiency of photovoltaic cells is reduced. Therefore, it would additionally be useful to down-convert higher energy photons (e.g., convert one blue photon to two or more red photons by quantum cutting) such that the excess energy of the higher energy photon is capable of exciting an electron in the photon-absorbing material and, therefore, be converted into electrical energy.

An approach for a photovoltaic apparatus or cell (e.g., solar cell) with enhanced optical down-conversion is described herein. In one embodiment, the present disclosure relates to an apparatus for producing electricity comprising at least one photon-absorbing semiconductor material, at least one cover layer located above the at least one photon-absorbing material, a down-conversion material interposed between at least two opposing reflective coatings and at least two electrically-conductive materials in contact with and located above and below the at least one photon-absorbing semiconductor material, wherein the down-conversion material is located above the at least one cover layer and wherein the at least two opposing reflective coatings increase the rate of down-conversion of at least one external photon in the down-conversion material to stimulate the emission of at least one internal photon which is exposed to the at least one photon-absorbing semiconductor material.

As used herein, when a layer or component of the presently described apparatus for producing electricity is located above another layer or component it is located closer to the side through which external photons first enter. For a typical solar cell, the top side therefore would be the side that faces the sun and the bottom side would face away and is not directly exposed to the external source of light.

An apparatus or device for producing electrical energy from light (e.g. sunlight) needs to fulfill in general only two functions. These are photogeneration of charge carriers (electrons and holes) in a photon-absorbing material, and separation of those charge carriers to contacts which are conductive. The conductive contacts can transmit the electricity for storage or immediate use.

The photovoltaic effect was first recognized in 1839 by French physicist Alexandre-Edmond Becquerel. However, solar power technology did not become feasible until Bell Laboratories found in 1954 that silicon doped with certain impurities are sensitive to light. Silicon is an example of a photon-absorbing semiconductor material. A photon-absorbing semiconductor material is needed to absorb photons and generate electrons. It can be configured as bulk materials which are cut into wafers and treated in a top-down method of synthesis. Silicon is the most common bulk semiconductor material. Alternatively, photon absorbing semiconductor materials may be configured as thin-films which are deposited onto supporting substrates. Substrates are needed for thin-films because elements such as wind and hail may damage or destroy the photon-absorbing materials without them. Silicon may be used in both bulk and thin-film configurations. It is within the scope and teachings of the present disclosure to cover both bulk and thin-film configurations used in producing the present apparatus for producing electricity from light.

The most prevalent bulk material for photovoltaic cells is crystalline silicon and is also known to those of ordinary skill in the art as solar grade silicon. Bulk silicon can be separated into multiple categories according crystallinity and crystal size in the resulting ingot, ribbon, or wafer. For all the embodiments of the present disclosure, it is possible that the at least one photon-absorbing semiconductor material is in the form of ingot, ribbon, or wafer. Monocrystalline silicon often is made using the Czochralski process. Single-crystal wafer cells may have increased cost as they must be cut from cylindrical ingots. Single-crystal wafer cells cannot be made square without a waste of refined silicon. Therefore, most monocrystalline silicon panels have uncovered gaps at the corners of four cells.

Poly- or multicrystalline silicon is made from cast square ingots which are large blocks of molten silicon carefully cooled and solidified. These cells are less expensive to produce than single crystal cells but are generally less efficient. Ribbon silicon may be formed by drawing flat thin films from molten silicon and having a multicrystalline structure. Therefore, these cells have lower efficiencies than multicrystalline silicon but have lower production costs. This approach does not require sawing from ingots.

In addition to silicon, a semiconductor material which may be used for photo-absorption of photons in accordance with the present disclosure is copper indium gallium diselenide (CIGS). CIGS can be configured in at least one layer, preferably in thin-film composites. Thin-film technologies reduce the amount of light absorbing semiconductor material required to make a photo-voltaic cell. This can lead to reduced costs when compared to solar cells made from bulk materials. A skilled artisan can, for example, utilize software for optical modeling of thin films to determine a layer design that provides a large optical field enhancement. Optimized optical design increases the fraction of photons entering the photovoltaic cell that is converted into electrical energy.

Higher efficiencies may be obtained by using optics to concentrate the incident light. The use of gallium increases the optical bandgap of the CIGS layer as compared to CIS (another photo-absorbing semiconductor material which may be utilized according to the present disclosure). Selenium allows for better uniformity across the layer of CIGS and so the number of recombination sites in the film are reduced which benefits the quantum efficiency and thus the conversion efficiency. CIGS films may be manufactured by various methods. These include vacuum-based processes which co-evaporate or co-sputter copper, gallium, and indium, and then anneal the resulting film with a selenide vapor to form a final CIGS structure. Non-vacuum based alternative processes deposit nanoparticles of the precursor materials on a substrate and sinter them in situ. Also, CIGS can be printed directly onto molybdenum coated glass sheets.

Cadmium telluride (CdTe) is another photon-absorbing semiconductor material which may be utilized within the scope and teachings of the present disclosure. CdTe is an efficient light-absorbing material which can be used primarily in thin-film photovoltaic cells. CdTe is relatively easy to deposit and therefore is considered suitable for large-scale production.

CIS is an abbreviation for general chalcopyrite films of copper indium selenide. An example is CuInSe₂ which is of interest for photovoltaic applications including elements from groups I, III and VI in the periodic table. CIS has high optical absorption coefficients and versatile optical and electrical characteristics which may be manipulated and tuned. CIS is a photon-absorbing semiconductor which may be utilized within the scope and teachings of the present disclosure. CIS most often is used to make a thin-film of photon absorbing material for a solar cell.

Organic polymers may also be used as a photon-absorbing semiconductor material. These may be made, for example, from polymers and small molecule compounds such as polyphenylene vinylene, copper phthalocyanine (a blue or green organic pigment) and carbon fullerenes. Organic polymers may be especially important for photovoltaic cells in which mechanical flexibility and disposability are important.

It is within the scope and teachings of the present disclosure that the above-mentioned photon-absorbing semiconductor materials may be used alone or in combination. Also, they may be in more than one layer, each layer having a different type of photon-absorbing semiconductor material or having combinations of the photon-absorbing semiconductor materials in separate layers. One of ordinary skill in the art would be able to optimally configure the amount and construction of the materials to maximize the quantum and overall efficiencies of a photovoltaic cell in accordance with the present disclosure.

At least one cover layer is located above the at least one photon-absorbing semiconductor material for the apparatus for producing electricity according to the present disclosure. The cover layer(s) may serve various purposes. This layer can serve as an n-type semiconductor. Generally, a commonly known solar cell is configured as a large-area p-n junction. A p-n junction is a junction formed by combining p-type and n-type semiconductors together in close contact. The term junction refers to the region where the two regions of the semiconductors meet. It can be thought of as the border region between the p-type and n-type blocks. Free carriers created by light energy are separated by the junction and contribute to current.

When the material is silicon, n-type dopant is diffused into one side of a p-type wafer or vice versa. If a piece of p-type silicon is placed in intimate contact with a piece of n-type silicon, then a diffusion of electrons occurs from the region of high electron concentration (the n-type side of the junction) into the region of low electron concentration (p-type side of the junction). When electrons diffuse across the p-n junction, they recombine with holes on the p-type side. The diffusion of carriers does not happen indefinitely however, because of an electric field which is created by the imbalance of charge immediately either side of the junction which this diffusion creates. The electric field established across the p-n junction creates a diode that promotes current flow in only one direction across the junction. Electrons may pass from the n-type side into the p-type side, and holes may pass from the p-type side to the n-type side. This region where electrons have diffused across the junction is called the depletion region because it no longer contains any mobile charge carriers.

An example of an n-type semiconductor which can form the n-type side of a p-n junction within the scope and teachings of the present disclosure is cadmium sulfide (CdS). It is yellow in color and is a semiconductor. Cadmium sulfide can be produced from volatile cadmium alkyls. An example is the reaction of dimethylcadmium with diethyl sulfide to produce a film of CdS using MOCVD techniques. It is important to point out that CdS may absorb those photons having a wavelength which may otherwise be usable or capable of absorption by a photon-absorbing semiconductor material such as CIGS. One of ordinary skill in the art will recognize that this may be partly why CdS generally has been deposited as a thin film. However, CdS is often a necessary part of a photovoltaic cell and absorption of otherwise usable photons by CdS, especially in the blue range of the solar radiation which reaches the earth, reduces the quantum efficiency of a photon-absorbing semiconductor material and therefore the overall efficiency of a solar cell.

Alternatively, the cover layer may have at least one additional conductive layer. For example, these may be ZnO and/or ITO (indium tin oxide), or a combination thereof. These conductors of electrical charge may be for example in the form of thin films. These additional conductive layers may be engineered to be as transparent as possible to allow light to pass through it so that it may reach the photon-absorbing semiconductor layer underneath. However, one of ordinary skill in the art will recognize that the at least one additional conductive layer may also, like the CdS layer, absorb photons which would otherwise be useful if absorbed by the photon-absorbing semiconductor material underneath. The additional conductive layer(s) can serve as ohmic contacts to transport photogenerated charge carriers away from the light absorbing material.

It is also within the scope and teaching of the present disclosure to include metal contacts which are located nearer to the top (closer to the sun) of a photovoltaic cell. Because these metal contacts are located nearer to the top, it would be preferable that they have the least surface area as possible to allow passage of external photons to the at least one photon-absorbing semiconductor materials located underneath.

As described herein, presently disclosed apparatus for producing electricity also includes at least two electrically-conductive materials located above and below the at least one photon-absorbing semiconductor material. An example of this material within the scope and teachings of the present disclosure is molybdenum. Alternatively, molybdenum is the conductive material below the at least one photon-absorbing material and a metal electrode is the electrically-conductive material above the at least one photon-absorbing material. Generally, the ability of molybdenum to withstand extreme temperatures without significantly expanding or softening makes it useful in applications that involve intense heat, including the manufacture of aircraft parts, electrical contacts, industrial motors, and filaments.

FIG. 2 shows an embodiment of the presently described apparatus for producing electricity. Glass is the bottom most layer and serves as the substrate upon which all other layers and coatings are placed. A layer of molybdenum is located above the glass substrate. A layer of CIGS as the photon absorbing semiconductor material is located on top of the layer of molybdenum. A layer of CdS is located on top of the layer of CIGS. Layers of ZnO and ITO are located above CdS. Down-conversion material with its reflective coatings are placed above CdS and ZnO/ITO so that external photons may be down-converted before reaching these materials. Glass is the top most layer which protects the presently described apparatus for producing electricity.

For the apparatus for producing electricity according to the present disclosure, a down-conversion material interposed between at least two opposing reflective coatings is provided. The down-conversion material is located above the at least one cover layer and the at least two reflective coatings increase the rate of down-conversion of at least one external photon in the down-conversion material to stimulate the emission of the at least one internal photon which is exposed to the at least one photon-absorbing semiconductor material.

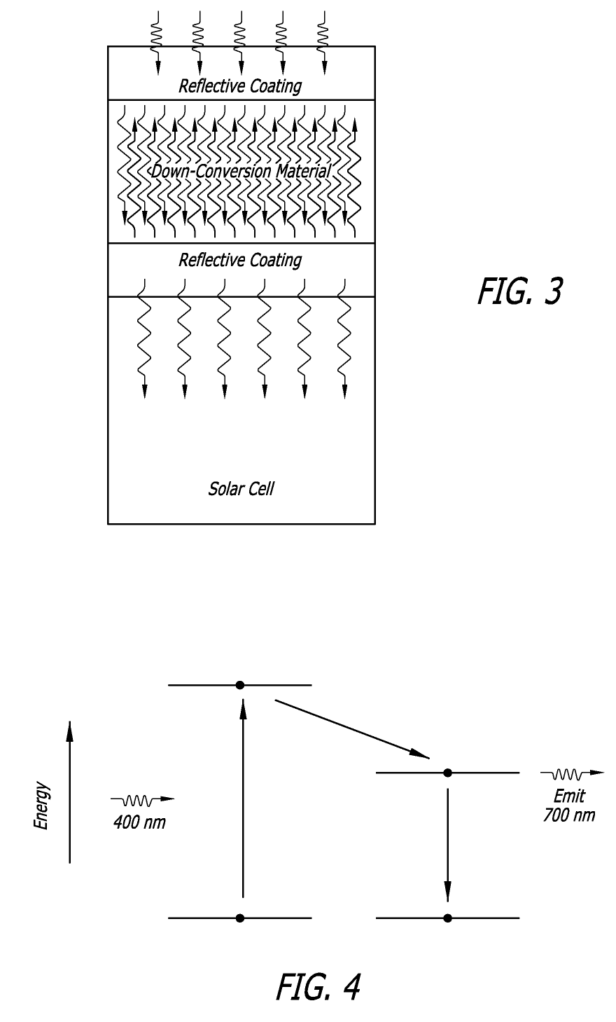

Down-conversion, within the scope and teachings of the present disclosure, refers to the emission, enhanced by stimulated emission, of internal photons caused by external or incoming photons. The emitted internal photons would be of lower energy than the external photons. External photons are those that come from an outside source, such as the sun, which hits a photovoltaic apparatus or device in accordance with the present disclosure. In optics, stimulated emission is the process by which, when perturbed by a photon, matter may lose energy resulting in the creation of another photon. Reflective coatings shown in FIG. 3 enhance or increase the rate of this down-conversion, i.e., they increase the speed of transition from higher energy to lower energy photons.

Electrons have energy in proportion to how far they are on average from the nucleus of an atom. However, quantum mechanical effects force electrons to take on quantized positions in orbitals. Electrons are found in specific energy levels of an atom. FIGS. 4 shows such energy levels of atoms in the down-conversion material and illustrates the process of stimulated emission whereby an external or incoming photon causes the emission of a lower energy photon. An external or incoming photon having a wavelength of 400 nm for example increases an electron of the host to a higher energy level and the subsequent relaxation causes the emission of a 700 nm photon. The 700 nm photon can pass through cover layers (e.g. CdS) which would otherwise absorb a 400 nm photon and be absorbed by an appropriate photon-absorbing semiconductor material so that it can be converted to electrical energy. Further, molecules in addition to atoms, may produce the required energy levels.

In another embodiment of the present disclosure, the down-conversion material comprises a host and a dopant. A host can be described as an optical absorbing host which absorbs incoming radiation (such as an external photon). A dopant adds desired energy levels which a generated internal photon should have. In FIG. 4, the desired energy levels are associated with the emission of a 700 nm photon which can be utilized. Additional dopants may facilitate this process and are within the scope and teachings of the present disclosure. Therefore, a down-conversion material, at the basic level, contains an absorber and an emitter. Alternatively, the host contains quantum dots and dopants include for example a transition metal or rarer earth atom. More specifically, when there is more than one dopant, a host relaxes an external photon to an energy level capable of absorption by a first dopant which stimulates the excitation and subsequent relaxation of a second dopant atom which stimulates the emission of one or more internal photons. The external photon may be a blue light photon. Further, molecules in addition to atoms, may produce the required energy levels as host(s) or dopant(s).

The dopant atom may alternatively comprise a neodymium atom or an ytterbium atom or both when there is more than one dopant included. Semiconductor quantum dots that absorb all blue photons (e.g., photons with wavelengths shorter than 500 nm) may be used for the down-conversion material. It has been demonstrated that energy transfer to dopants dramatically can be enhanced in nano-scale semiconductors. Quantum dots are one example of a nano-scale semiconductor. In addition, the nano-scale semiconductor may be doped with rare earth atom preferably those previously used for quantum cutting (e.g. ytterbium, neodymium, or combinations thereof). For example, a ytterbium/neodymium pair may become ionized if the pair is optically activated.

Although FIG. 4 shows emission of one internal photon (700 nm) as a result of down conversion of a higher energy photon (400 nm), it is possible to produce more than one photon from one external photon. This may be achieved by quantum cutting. When an external photon has an energy that is at least about two times the band gap energy of a photon-absorbing material, relaxing the energy of the external photon may stimulate the emission of at least two internal photons. When for one photon more than one is generated, ultimate increase in efficiency of a photovoltaic cell is observed.

In accordance with the present disclosure, the down-conversion material is interposed between at least two opposing reflective coatings, which in one embodiment, may be approximately parallel. These coatings essentially sandwich the down-conversion material. Also, they may comprise a dielectric material. Alternatively, the reflective coatings may comprise a material selected from the group consisting of magnesium fluoride, silicon dioxide, tantalum pentoxide, zinc sulfide and titanium dioxide or a combination thereof. These may be in one or more layers, alone or in combination. Without being bound by theory, the reflective coatings may be considered as forming dielectric mirrors. Dielectric mirrors are types of mirrors which are composed generally of multiple thin layers of dielectric material. By choice of the type and thickness of dielectric layers, one of ordinary skill in the art may design optical coatings with specified reflectivity at various wavelengths of light. These mirrors may be constructed to have high reflectivity over a narrow range of wavelengths or be made to reflect a broad spectrum of light such as the entire visible range.

Dielectric mirrors function based on the interference of light reflected from the different layers of dielectric stack. This is the same principle used in multi-layer anti-reflection coatings, which are dielectric stacks which have been designed to minimize rather than maximize reflectivity. Simple dielectric mirrors function like one-dimensional photonic crystals, consisting of a stack of layers with a high refractive index interleaved with layers of a low refractive index. The thicknesses of the layers are chosen such that the path-length differences for reflections from different high-index layers are integer multiples of the wavelength for which the mirror is designed. The reflections from the low-index layers have exactly half a wavelength in path length difference, but there is a 180-degree difference in phase shift at a low-to-high index boundary, compared to a high-to-low index boundary, which means that these reflections are also in phase. In the case of a mirror at normal incidence, the layers have a thickness of a quarter wavelength. Other designs have a more complicated structure generally produced by numerical optimization. In the latter case, the phase dispersion of the reflected light can also be controlled. In the design of dielectric mirrors, an optical transfer-matrix method can be used.

The above described information and technique regarding dielectric mirrors may be applied to the present reflective coatings sandwiching the down-conversion material. As an example, when relaxation to or generation of a lower energy photon such as that having a wavelength of 700 nm from 400 nm is desired, the reflective coatings will be designed with an appropriate thickness which makes it reflective at 700 nm. Using available computer software, one of ordinary skill in the art should be able to determine the thicknesses and refractive indices of the coatings which allow reflection for the emitting wavelength.

The presently described reflective coatings may alternatively be in at least two layers wherein each layer comprises a different dielectric material, for example, magnesium fluoride and/or titanium dioxide. In another embodiment, the reflective coatings may comprise rugates. Rugates allow for continuous change of refractive indices and composition of material over distance without switching of materials. Optical constants are allowed to change smoothly along a film axis with optically inhomogeneous coatings (gradient index of layers) and with refractive index profile that is not constant.

The reflective coatings allow increase in the rate of stimulated emission of at least one internal photon from down-conversion of at least one external photon. Within the scope and teachings of the present disclosure the reflective coatings do not externally reflect light which may otherwise reach the photon-absorbing semiconductor material. Therefore, alternatively, photons having a wavelength of from about 600 to about 900 nm are not externally reflected by the reflective coatings. “Externally reflect” in accordance with the present disclosure describes the situation in which an external photon does not penetrate the reflective coating at all but is reflected off by the reflective coating(s) away from the described apparatus. Therefore, external photons which are externally reflected never reach the photon-absorbing semiconductor material. For photons which would not be absorbed by a cover layer, there is no need for down-conversion and they should be allowed to reach the CIGS layer, for example. A skilled artisan, by using the teachings of the present disclosure, should be able to choose and arrange the reflective coatings such that they do not impede the passing of photons which are not in need of down-conversion.

The down-conversion material can be viewed as a cavity which consists of two mirrors (reflective coatings). These mirrors are arranged such that light bounces back and forth. Photons of a specific wavelength are amplified. The reflective coatings ensure that these photons make many passes through the down-converting material. So when a photon having a higher energy (such as of 400 nm) enters the down-converting material, it stimulates the emission of a 700 nm photon. The 700 nm photon may be reflected back and forth by the reflective coatings and retained in the cavity so that other 700 nm photons can also be produced in the cavity, creating an increase in intensity. This allows for the ultimate increase in the down-conversion rate of an external photon having higher energy (e.g. 400 nm) to an internal photon having a lower energy (700 nm). The 700 nm photon emission competes with other processes which may not result in the emission of the desired 700 nm photon from a 400 nm photon. The reflective coatings allow for resonation of the relaxed photon which can be passed through a cover layer which would otherwise absorb the 400 nm photon and reach the photon-absorbing semiconductor material. When the number of particles in one excited state exceeds the number of particles in some lower-energy state, population inversion is achieved and the amount of stimulated emission due to light that passes through is larger than the amount of absorption. This principle which allows the reflective coatings to serve their role as they should is within the scope and teachings of the present disclosure.

In another embodiment of the present disclosure, the provided external photon has a wavelength of about 300 nm to about 500 nm. Alternatively, the down-conversion causes the emission of one or more internal photons having a wavelength of about 600 nm to about 900 nm. These ranges cover the conversion of one or more blue photons to one or more red photons.

The present disclosure also relates to methods of producing electrical energy. In one embodiment, a method of producing electrical energy comprises providing a at least one photon-absorbing semiconductor material, providing an external photon to a down-conversion material interposed between at least two opposing reflective coatings which increase the rate of down-conversion of at least one external photon within the down-conversion material to at least one internal photon; and exposing the at least one internal photon to the at least one photon-absorbing semiconductor material to generate charge carriers within the at least one photon-absorbing semiconductor material; wherein the charge carriers migrate to at least two electrically-conductive materials located above and below the at least one photon-absorbing semiconductor material whereby electrical energy is produced.

In another embodiment for the present methods of producing electrical energy, the external photon has a wavelength of about 300 nm to about 500 nm. Alternatively, the at least one internal photon has a wavelength of about 600 nm to 900 nm.

In another embodiment for the present methods of producing electrical energy, the reflective coatings are approximately parallel. Alternatively, the reflective coatings comprise a dielectric material. In another embodiment, the reflective coatings comprise a material selected from the group consisting of magnesium fluoride, silicon dioxide, tantalum pentoxide, zinc sulfide, and titanium dioxide; or a combination thereof. Alternatively, the reflective coatings may comprise rugates. In another embodiment, the reflective coatings do not externally reflect the at least one external photon having a wavelength of from about 600 nm to about 900 nm. Alternatively, the reflective coatings are in at least two layers wherein each layer comprises a different dielectric material. In another embodiment, the down-conversion material comprises a host and a dopant. Alternatively, the host comprises quantum dots and the dopant comprises a transition metal or a rare earth atom.

The teachings relating to the various embodiments of the apparatus for producing electricity according to the present disclosure apply to the presently disclosed methods for producing electricity.

The appended claims describe the invention and a skilled artisan will understand and be capable of modifying the herein-disclosed invention readily and without undue experimentation while not departing from the spirit and scope of the invention.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. An apparatus for producing electricity comprising:
at least one photon-absorbing semiconductor material;
at least one cover layer located above said at least one photon-absorbing semiconductor material;
a down-conversion material interposed between at least two opposing reflective coatings; and
at least two electrically-conductive materials located above and below said at least one photon-absorbing semiconductor material;
wherein said down-conversion material is located above said at least one cover layer; and wherein said at least two opposing reflective coatings increase the rate of down-conversion of at least one external photon in said down-conversion material to stimulate the emission of at least one internal photon which is exposed to said at least one photon-absorbing semiconductor material.

2. The apparatus of claim 1, wherein said reflective coatings comprise a dielectric material.

3. The apparatus of claim 1, wherein said reflective coatings comprise a material selected from the group consisting of magnesium fluoride, silicon dioxide, tantalum pentoxide, zinc sulfide, and titanium dioxide; or a combination thereof.

4. The apparatus of claim 1, wherein said reflective coatings comprise rugates.

5. The apparatus of claim 1, wherein said reflective coatings are in at least two layers wherein each layer comprises a different dielectric material.

6. The apparatus of claim 1, wherein said reflective coatings do not externally reflect said at least one external photon having a wavelength of from about 600 nm to about 900 nm.

7. The apparatus of claim 1, wherein said reflective coatings are approximately parallel.

8. The apparatus of claim 1, wherein said down-conversion material comprises a host and a dopant.

9. The apparatus of claim 8, wherein said host comprises quantum dots and said dopant comprises a transition metal or a rare earth atom.

10. The apparatus of claim 1, wherein said down-conversion of said external photon stimulates the emission of at least two internal photons.

11. The apparatus of claim 1, wherein said at least one photon-absorbing semiconductor material is selected from the group consisting of CIGS, silicon, CdTe, CIS, and organic polymer; or a combination thereof.

12. The apparatus of claim 1, wherein said at least one photon-absorbing semiconductor material is CIGS.

13. The apparatus of claim 1, wherein said at least one external photon has a wavelength capable of being absorbed by said cover layer.

14. The apparatus of claim 1, wherein said external photon has a wavelength of about 300 nm to about 500 nm.

15. The apparatus of claim 1, wherein said down-conversion causes the emission of one or more internal photons having a wavelength of about 600 nm to about 900 nm.

16. The apparatus of claim 1, further comprising a substrate layer as bottom layer and a protective layer as top layer.

17. The apparatus of claim 16, wherein said substrate layer and said protective layer each comprises glass.

18. The apparatus of claim 1, wherein said at least one cover layer comprises an n-type semiconductor.

19. The apparatus of claim 18, wherein said n-type semiconductor is CdS.

20. The apparatus of claim 1, wherein said at least one cover layer further comprises at least one additional conductive material located on top of said n-type semiconductor.

21. The apparatus of claim 20, wherein said least one additional conductive material comprises ZnO and/or ITO, or a combination thereof.

22. The apparatus of claim 1, wherein the electrically-conductive material in contact with and located below said at least one photon-absorbing semiconductor material comprises molybdenum.

23. An apparatus for producing electricity comprising
a glass substrate;
a layer of molybdenum located above said glass substrate;
a layer of CIGS located on top of said layer of molybdenum;
a layer of CdS on top of said layer of CIGS;
a layer of ZnO and a layer of ITO as cover layers;
a down-conversion material interposed between at least two opposing reflective coatings,
a metal electrode located above said layer of CIGS; and
glass as a top protective layer;
wherein said down-conversion material is located above said at least one cover layer; and wherein said at least two opposing reflective coatings increase the rate of down-conversion of at least one external photon in said down-conversion material to stimulate the emission of at least one internal photon which is exposed to said layer of CIGS.

24. A method of producing electrical energy comprising:
providing a at least one photon-absorbing semiconductor material;
providing an external photon to a down-conversion material interposed between at least two opposing reflective coatings which increase the rate of down-conversion of at least one external photon within said down-conversion material to at least one internal photon; and
exposing said at least one internal photon to said at least one photon-absorbing semiconductor material to generate charge carriers within said at least one photon-absorbing semiconductor material;
wherein said charge carriers migrate to at least two electrically-conductive materials located above and below said at least one photon-absorbing semiconductor material whereby electrical energy is produced.

25. The method of claim 24, wherein said external photon has a wavelength of about 300 nm to 500 nm.

26. The method of claim 24, wherein said at least one internal photon has a wavelength of about 600 nm to about 900 nm.

27. The method of claim 24, wherein said reflective coatings are approximately parallel.

28. The method of claim 24, wherein said reflective coatings comprise a dielectric material.

29. The method of claim 24, wherein said reflective coatings comprise a material selected from the group consisting of magnesium fluoride, silicon dioxide, tantalum pentoxide, zinc sulfide, and titanium dioxide; or a combination thereof.

30. The method of claim 24, wherein said reflective coatings comprise rugates.

31. The method of claim 24, wherein said reflective coatings do not externally reflect said at least one external photon having a wavelength of from about 600 nm to about 900 nm.

32. The method of claim 24, wherein said reflective coatings are in at least two layers wherein each layer comprises a different dielectric material.

33. The method of claim 24, wherein said down-conversion material comprises a host and a dopant.

34. The method of claim 33, wherein said host comprises quantum dots and said dopant comprises a transition metal or a rare earth atom.
